(19) United States
(12) Patent Application Publication
(10) Pub. No.: US 2023/0226668 A1
(43) Pub. Date: Jul. 20, 2023

(54) Fencing Tool

(71) Applicant: Jesse Kendrick, Harrodsburg, KY (US)

(72) Inventor: Jesse Kendrick, Harrodsburg, KY (US)

(21) Appl. No.: 18/098,347

(22) Filed: Jan. 18, 2023

Related U.S. Application Data
(60) Provisional application No. 63/300,384, filed on Jan. 18, 2022.

(51) Int. Cl. B25B 13/50

(52) U.S. Cl. CPC B25B 13/50; E05D 5/10

(57) ABSTRACT

A fencing tool for use with a gate pin and a related method of attaching a gate pin to a fence post with the fencing tool is provided. The fencing tool includes a body having opposed ends. The fencing tool further includes a socket defined within the body. The socket is configured to engage the hinge or gate pin for attachment to a fence.

This application claims the benefit of U.S. Provisional Patent Application Ser. No. 63/300,384, filed on Jan. 18, 2022, the disclosure of which is incorporated herein by reference.

### TECHNICAL FIELD

This disclosure relates generally to the field of fencing tools and, more particularly, to a socket-like device that may be used to easily and efficiently install gate pins to wooden fence posts.

### BACKGROUND

It is well known for homeowners, businesses, farmers and the like to utilize fences for a variety of reasons. For example, fences may be utilized to: (i) act as boundary fencing to enclose an area and/or demarcate a piece of real property; (ii) act as a barrier to either keep livestock or pets in and/or predators out of an area; (iii) act as a privacy fence; (iv) act as perimeter fencing to prevent trespassing; and (v) act as decorative fencing to enhance the appearance of a property. A fence is a structure that is usually constructed from posts that sit vertically and are typically set into the ground with concrete. The fence or backer rails run horizontally from post to post. Alternatively, the posts may be connected by boards, wires or rails. Different materials may be used for the fence, but wood is commonly used.

Most fences typically utilize a hinge or gate pin that is designed to screw into a wooden post. The hinge or gate pin may be paired with a female strap hinge in order to hang a gate in conjunction with the wooden post such that chain link gate(s) may be installed/attached to a wood post. One problem with hinge or gate pins is that there is not a specific tool configured for use with the pin for installation. Generally, one may utilize a pipe wrench to turn the threaded pin for assembly or disassembly. While a pipe wrench may work, it is not perfectly suited for use with a gate pin. Specifically, a pipe wrench suffers from certain disadvantages, such as being relatively heavy, expensive (especially for bigger models) and not particularly easy or comfortable to use.

Accordingly, there is a need for an improved fencing tool that is specifically designed for use with a gate or hinge pin and is not only easy to use with said pin but is compact and easily transported.

### SUMMARY

In accordance with one aspect of the disclosure, a fencing tool for use with a gate pin is to provided. The fencing tool includes a body having opposed ends. The fencing tool further includes a socket defined within the body. The socket is configured to engage the hinge or gate pin for attachment to a fence.

In one embodiment, the body of the fencing tool is substantially cylindrically-shaped. Furthermore, the opposed ends of the body are round. In another embodiment, the first opposed end has a cut-out portion. Furthermore, the cut-out portion is square-shaped. In yet another embodiment, the second opposed end includes the socket.

In another possible embodiment, the socket is substantially U-shaped. The socket has two notches forming a substantially rectangular cross-section. The socket extends an entire length of the body of the tool. The socket defines an inner channel within the body. The socket extends vertically from a center position of the second opposed end to a top of the body. The socket forms an elongate U-shape in the top of the body. The fencing tool has a hole adjacent to the first opposed end is positioned within the top of the body. The hole extends to the inner channel.

In accordance with another aspect of the disclosure, a fencing device is provided. The fencing device includes a body having a first face and a second face. The fencing device further includes a groove defined in the first face. The groove is configured to receive a pin for securing to a fence.

In one possible embodiment, the first face has an opening. The groove extends a length of the body to the opening.

In accordance with yet another aspect of the disclosure, a method of attaching a gate pin to a fence post is provided. The method includes the steps of: (i) providing a fencing tool with a body and a socket defining an inner channel in said body; (ii) engaging the gate pin with the socket; and (iii) attaching the gate pin to the fence post by actuating the fencing tool.

In one possible embodiment, the actuating step is performed by a ratchet. In another possible embodiment, the actuating step is performed by a drill.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIG. 1 is a side view of a representative gate or hinge pin forming one aspect of this disclosure;

FIG. 2 is a front perspective view of a fencing tool for use with a gate pin forming one aspect of this disclosure;

FIG. 3 is a rear perspective view of the fencing tool for use with a gate pin forming one aspect of this disclosure;

FIG. 4 is a front view of the fencing tool for use with a gate pin forming one aspect of this disclosure;

FIG. 5 is a rear view of the fencing tool for use with a gate pin forming one aspect of this disclosure;

FIG. 6 is a bottom perspective view of the fencing tool for use with a gate pin forming one aspect of this disclosure;

FIG. 7 is a side perspective view of the fencing tool for use with a gate pin forming one aspect of this disclosure;

FIG. 8 is a top view of the fencing tool for use with a gate pin forming one aspect of this disclosure; and

FIG. 9 is a cross-sectional view through Section 9-9 in FIG. 8 of the fencing tool from for use with a gate pin forming one aspect of this disclosure.

### DETAILED DESCRIPTION

In the following detailed description, reference is made to the accompanying drawings and photographs that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a fencing tool for use with a gate pin, gate hinge, or hinge pin is hereinafter described.

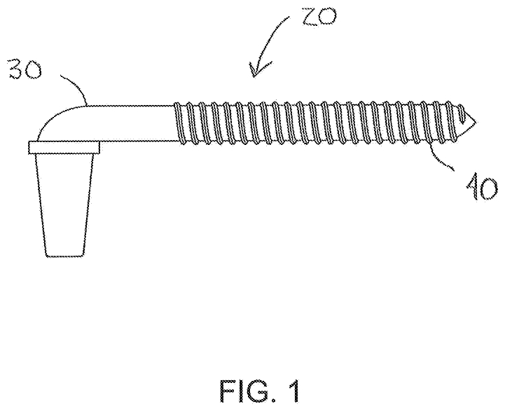

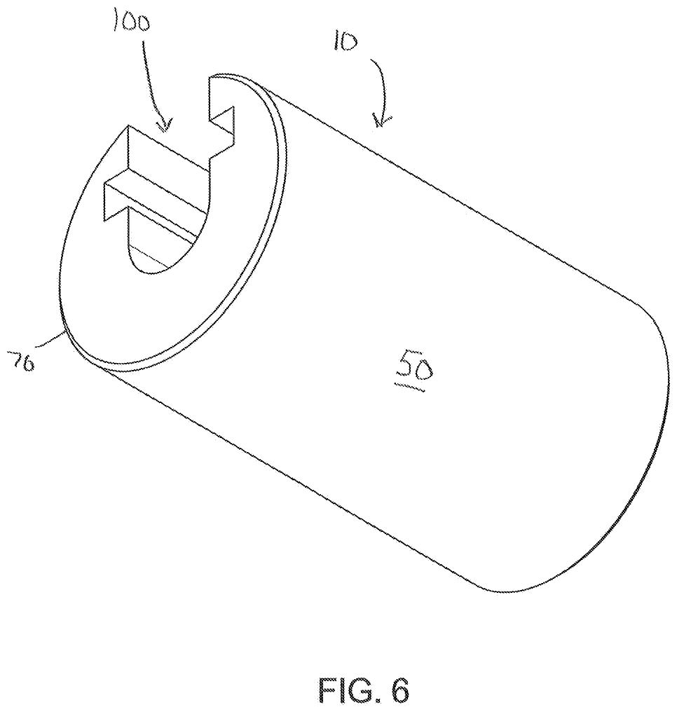

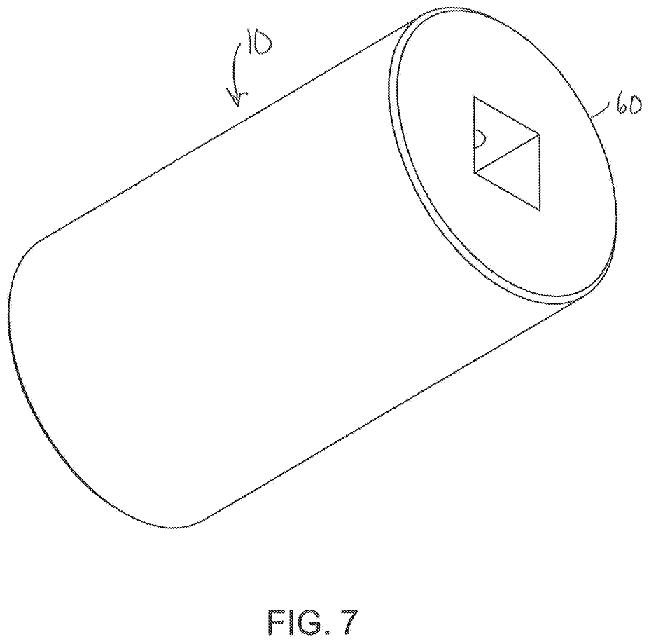

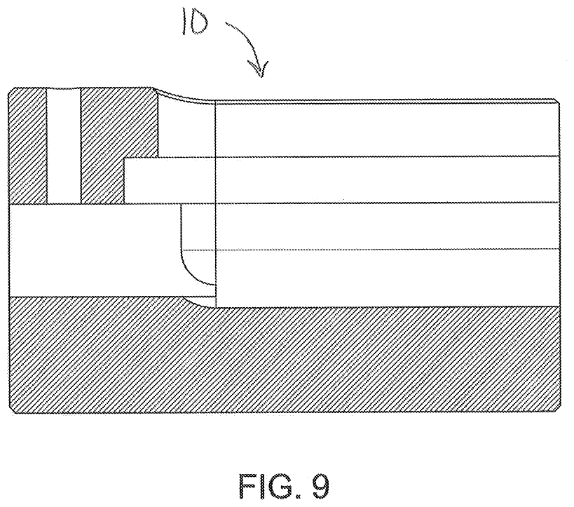

Reference is now made to FIGS. 1-9, which illustrate a fencing tool or device 10 that may be used with a gate pin, gate hinge, or hinge pin 20. With respect to FIG. 1, a representative gate pin 20 that may be used with a fence to hang, hold or connect a gate, such as a farm gate to a post or wall. Although different sized gate pins may be utilized based on size of the fence or gate, the gate pin 20 shown in FIG. 1 is relatively standard in shape. Namely, the gate pin 20 may be made of a rigid material, such as steel and has a substantially J-shape with body 30 and a useable thread portion 40. The gate pin 20 may be a J-bolt male hinge that works in conjunction with female strap hinges and is suitable for most fencing gates as it can be installed on wood posts and the like.

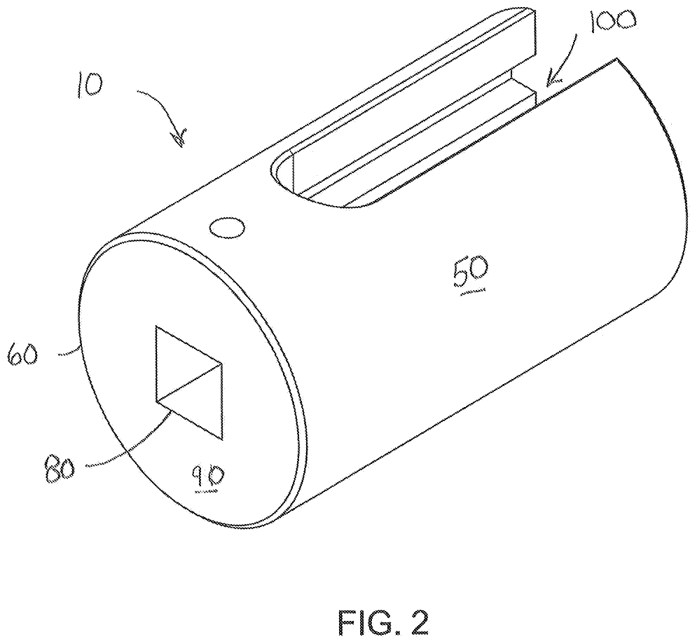

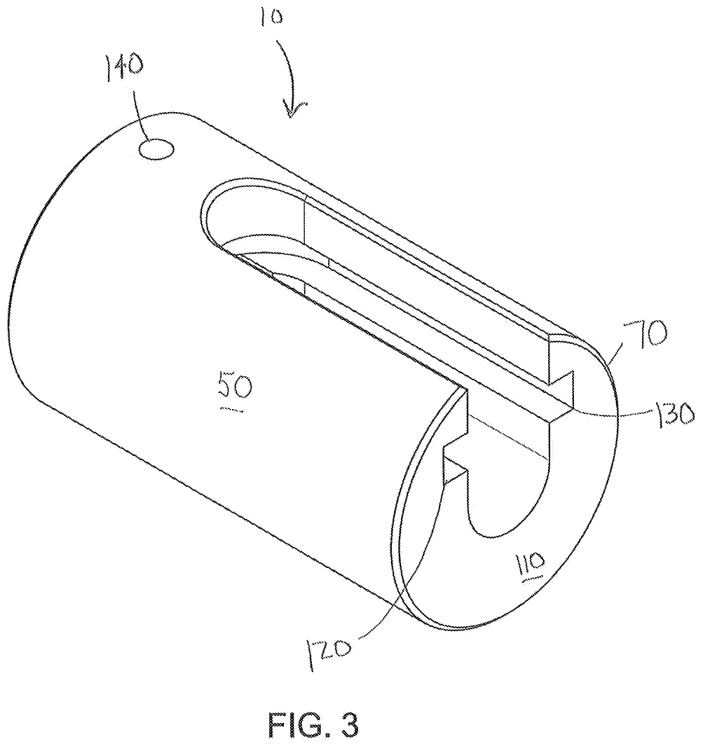

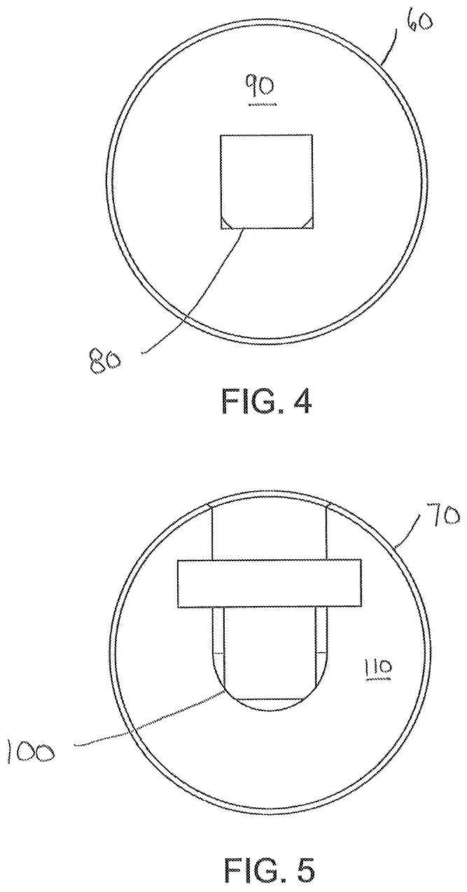

Turning to FIGS. 2-9, one embodiment of a fencing tool 10 is illustrated. As shown in these drawing figures, the fencing tool 10 has a substantially cylindrically-shaped body 50 with opposed ends 60, 70. Of course, it should be appreciated that the fencing tool may come in different sizes and shapes. As perhaps best shown in FIG. 4, the first opposed end 60 is round with a substantially square cut-out portion 80 in a center of a first face 90 of the first end. Turning back to FIG. 3, the second end 70 is also substantially round, but has a groove or socket 100 cut through a second face 110 of the second end. As perhaps best shown in FIG. 5, the socket 100 is substantially U-shaped in the face 110 with two notches 120, 130 cut out near the top of the tool that form a substantially rectangular cross-section.

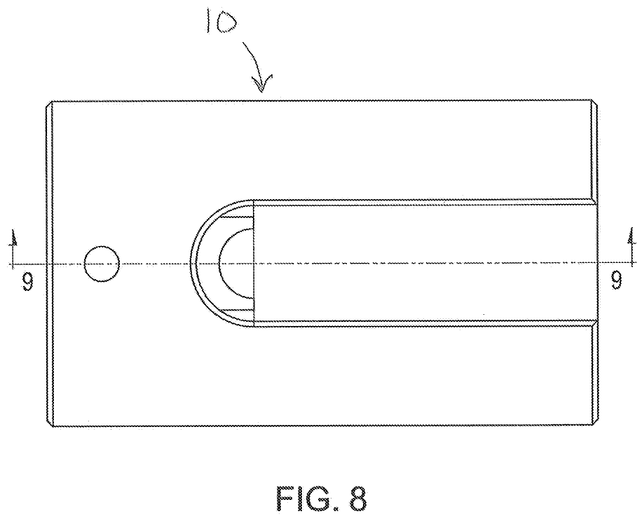

The socket 100 is positioned in the body 50 for receiving the gate pin 20 such that the tool 10 engages the pin 20. As a result, the gate pin 20 may be quickly and easily installed through a square or round wooden post. The socket 100 extends along an entirety of the interior portion of the tool, i.e., from end to end. In other words, a hollow chamber or inner channel exists within the body 50 from one end 60 to the other end 70 of the device 10. The socket 100 extends vertically from approximately the center of the second end 70 to the top, such that the tool 10 is partially open. The socket 100 forms an elongated U in the top portion of the tool 10 (as perhaps beset shown in FIG. 8). A hole 140 is spaced from the bottom of the elongate U in the top portion of the tool 10. The hole 140 extends through the tool 10 until it reaches the inner channel existing with the body 50 of the tool.

In use, the fencing tool 10 acts as a gate pin socket to work with the gate pin 20 in order to attach to the gate to the fence. Typically, the fencing tool 10 or gate pin socket is put into action by using a ratchet, such as a ½ inch drive ratchet. Of course, it should be appreciated that other sized ratchets may be used with the fencing tool 10. Alternatively, a battery powered drill impact may be used to put the fencing tool 10 or gate pin socket into action with the gate pin 20. An air impact drill may also be utilized to put the fencing tool 10 or gate pin socket into action with the gate pin 20.

Advantageously, the fencing tool 10 disclosed herein is compact such that it may easily be carried by the operator or use to a particular work site and around the work site as a fence is installed or repaired. The design of the fencing tool 10 allows it to be easily used by the owner/operator to quickly and efficiently install the gate pin 20. Furthermore, the fencing tool 10 is made to be durable and long-lasting.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the disclosure in various embodiments and with various modifications as are suited to the particular use contemplated.

1. A fencing tool for use with a gate pin, comprising:
a body having opposed ends; and
a socket defined within the body, said socket configured to engage the hinge or gate pin for attachment to a fence.

2. The fencing tool according to claim 1, wherein the body is substantially cylindrically-shaped.

3. The fencing tool according to claim 2, wherein each of the opposed ends is round.

4. The fencing tool according to claim 1, wherein the first opposed end has a cut-out portion.

5. The fencing tool according to claim 4, wherein the cut-out portion is square-shaped.

6. The fencing tool according to claim 1, wherein the second opposed end includes the socket.

7. The fencing tool according to claim 1, wherein the socket is substantially U-shaped.

8. The fencing tool according to claim 7, wherein the socket has two notches forming a substantially rectangular cross-section.

9. The fencing tool according to claim 8, wherein the socket extends an entire length of the body.

10. The fencing tool according to claim 9, wherein the socket defines an inner channel within the body.

11. The fencing tool according to claim 10, wherein the socket extends vertically from a center position of the second opposed end to a top of the body.

12. The fencing tool according to claim 11, wherein the socket forms an elongate U-shape in the top of the body.

13. The fencing tool according to claim 12, wherein a hole adjacent to the first opposed end is positioned within the top of the body.

14. The fencing tool according to claim 13, wherein the hole extends to the inner channel.

15. A fencing device, comprising:
a body having a first face and a second face; and
a groove defined in the first face,
whereby the groove is configured to receive a pin for securing to a fence.

16. The fencing device according to claim 15, wherein the first face has an opening.

17. The fencing device according to claim 16, wherein the groove extends a length of the body to the opening.

18. A method of attaching a gate pin to a fence post, comprising:
providing a fencing tool with a body and a socket defining an inner channel in said body;
engaging the gate pin with the socket; and
attaching the gate pin to the fence post by actuating the fencing tool.

19. The method according to claim 18, wherein the actuating is performed by a ratchet.

20. The method according to claim 18, wherein the actuating is performed by a drill.
